(19) United States
(12) Patent Application Publication
(10) Pub. No.: US 2007/0051560 A1
(43) Pub. Date: Mar. 8, 2007

(54) Lift-off ladder-top support and tray

(76) Inventor: Jean V. Rittmann, Everett, WA (US)

Correspondence Address: Jean V. Rittmann, 2016 Broadway Ave., Everett, WA, 98201-2318, US

(21) Appl. No.: 11/512,959

(22) Filed: Aug. 31, 2006

Related U.S. Application Data
(60) Provisional application No. 60/714,446, filed on Sep. 6, 2005.

(51) Int. Cl. E04G 3/00; E06C 7/06

(52) U.S. Cl. 182/129; 182/214

(57) ABSTRACT

The invention is substantially a box (5 walls, front wall absent) with a top inside-surface prop-stop means to hold a ladder's top portion a distance away from any vertical surface on which that ladder leans. The box is of a width to confine the outside sides of a prior art ladder's rails; of a top-wall depth to rest atop of a portion of same ladder; of a depth to substantially prop same ladder away from a vertical wall, of a length such that, when positioned as described, the box's bottom-wall's front edge can brace against the rear side of rails of same ladder.

### CROSS-REFERENCE TO RELATED APPLICATIONS

This application claims priority of Provisional Application # 60/714,446, file date: Sep. 6, 2005, App.: Jean V. Rittmann

### STATEMENT REGARDING FED. SPONSORED RESEARCH OR DEVEL.

Not Applicable

### REFERENCE TO A MICROFICHE APPENDIX

Not Applicable

### BACKGROUND OF INVENTION

This invention relates to fire escape, ladder, or scaffold. More specifically, platform with ladder as support.

Ladders of issue include one-fold A-frame folding ladders, straight ladders (slide or unfolding), and scaffold ladders, including pivotally connected ladders. Many such ladders are for building, repairing, painting and the like of vertical walls, and surfaces near such walls. Accessories for ladders include trays, (for supplies) and stabilizing supports.

Each ladder type has disadvantages. One-fold folding A-frame ladders have limited height, need sure footing for all four legs, & need a substantially level surface to correctly unfold its A frame. They have nearly no room for painting supplies and the like on the ladder platform. Inside floors provide for such secure footing, but outside ground can be uneven (like 2 legs on the sidewalk and two legs in the garden area abutting/near the building.

Straight ladders have disadvantages. To work on a wall a user steps many steps down form the top of a ladder to be at a distance horizontally away from the wall. Prior Art FIG. 1a is a sketch of a user painting on a ladder, front view. It shows the user cannot work much directly in front of them much because the ladder is in the way. By painting to a user's side, a user counterbalances themselves sideways against the ladder, which is a stressful position for a user, can dig into the wood by the sideways rubbing of the ladder's top portion, and can unbalance the ladder. (It's an OSH “don't”). Ladder-top friction pads and accessory side supports are available to sideways-stabilize a ladder. But side supports make the ladder more top-heavy and harder to balance when moving (see below). A straight ladder is often 16 inches wide, and a user's arm can extend sideways an average of 2 to 2.5 feet, plus brush length. Most users paint with their favored hand, to do a good job. Prior Art FIG. 1b is a sketch of a user painting on a ladder, top view. It shows that, because the ladder crosses in front of a user's chest, it is nearly impossible to paint on the users non-favored side of the ladder. That means that a straight ladder would have to be repositioned every one to 1.5 feet sideways. This becomes more involved when a user is working on a roof-pitched wall, where the needed ladder height changes with the roof pitch height.

Prior Art FIG. 1c shows views of users moving a straight ladder. As depicted in drawing, straight ladders are tall such that most of their weight is above a persons arm level. The weight above arm/grabbing level often includes a ladder-portion overlap. When picked up and moved, straight ladders must be levered and balanced into place. This can be dangerous. Moving such a ladder can damage walls when unbalanced, or the ladder can fall or be dropped before it is secured in place. Sliding a ladder vertically taller, either by hand or mechanism, still has the balancing problem to secure against a wall. Additionally, any tray for supplies would best be attached after the ladder is erected, to prevent a more top-heavy condition when moving. So not only must a straight ladder be moved often because a user can only paint to the side, but any tray may need to be removed with every move. Prior art trays, often flat, provide little security against spillage or dropping if accidentally bumped. This often means limited supplies near the top of a ladder. Without much security for supplies, many users, doing more than just painting, haul supplies up and down the ladder several trips before ladder must be moved. Climbing up and down a ladder is not fun, always includes the possibility of a potential fall, and is time consuming. Standoffs (RHS drawing—phantom lines), hold the ladder back from the wall like 10″, but is 4′ wide, so cannot mount everywhere, like close to windows and roof pitch.

On exterior walls, may buildings have eves which must be worked on. As eves overhang the walls, a straight ladder is often not tall enough for a user to work on the eves without leaning back. This is shown in Prior Art FIG. 1d is a sketch of a user painting a truss, side view. Many hold onto an eve structure, like an overhead truss. This is because one must step farther down the ladder to reach farther away from the supporting wall. Leaning back can be dangerous. Holding on to an above-head structure, like a truss, is not a secure hold. Such a lean-back can cause a user to fall—fall from a high location. A user often puts the straight ladder in an almost vertical position to reach as high as possible. An already near-vertical ladder can lift off the wall, and take a user down. Leaning a straight ladder against the gutters also does not provide access to working on the eves.

A ladder's force against a wall, or horizontally-supporting structure, is calculated by equations for equilibrium. Referring to Prior Art FIG. 1e, a force analogy diagram:
ΣF_{X}=0=N_{A}−μN_{B}
ΣF_{Y}=0=N_{A}=μN_{A}−#
ΣM_{A}=0=−#(0.5L cos Ø)+N_{B}(L cos Ø)−μN_{B}(12 sin Ø)
OSH recommends footing the ladder 1 meter out for every meter tall.

Exterior work has the benefit of ground and cement, both highly frictional surfaces (μN_{B}).

Pivotally-connected ladders have problems. U.S. Pat. No. 4,216,844 entitled FITTING FOR JOINTS OF LADDER SECTIONS, granted Aug. 12, 1980, by Klafs is an example of the locking joints that connect ladder sections for multi-ladders. The locking joints on these ladders must be fully and properly secured so they do not collapse, especially in use. The joints can easily rust, some say in just one year. (Likely because soft plating on joint parts rubs off when joints are rotated, which is aggravated by frequent use.) This rusting can prevent the joints from locking and/or unlocking. It can keep the ladder from unfolding or from fully folding the ladder back. Some users lay the ladder on the floor, stand on one section, and try to pry another section open or press it closed. A user's fingers can get cut up on the joints while trying to adjust/lock/unlock the joints or fold or unfold the ladder. When not properly locked, a ladder can collapse causing a fall. Many users find these problems frustrating enough to discontinue using such a ladder. (A homeowner who has fewer projects more often chooses a ladder that is simpler to use). Some pivotally-connected ladders may be assembled like an upside-down italic capital L, such that the ladder's top portion is away from the wall, which is desirous for working on trusses. Prior Art FIG. 2 is a sketch of a user on such an L-formed multi-ladder. This position places a substantial stress on the small-diameter joints. If a collapse occurs, a user could crash against the surface on which they work, then fall. Multi-ladders can have four 3′ or 4′ segments. A depicted 12′ ladder could be made 9′ tall and would stand 3′ away from the wall. This distance can not be made smaller. To the average eye, this L position does not look safe. As most user's arm is 2′ to 2.5′ long, the user cannot reach the wall against which the ladder rests without leaning over, which adds further stress to the joints, and is not a comfortable position. Commonly, such an angle would be supported by a cross-bar. Such a bar is shown as notation 10 in U.S. Pat. No. 4,121,692 entitled LADDER TRAY, granted Oct. 24, 1978, by Morawski, FIG. 1; and as support 14 in FIG. 1 of U.S. Pat. No. 4,460,063 entitled STEP-LADDER WORK BENCH, granted Jul. 17, 1984, by Casada. A pivotally-connected ladder positioned like in Prior Art FIG. 2 has platform rungs (steps) which do not provide a surface by themselves for supplies. If a board were put over the horizontal rungs, supplies it would place additional stress on the joints, and still have no security from being bumped off.

Morawski's tray, as shown in his FIG. 2, has rubber feet 44 with a benefit detailed in specification P. 3, lines 22-32, which recites, “In order to improve the engagement between the frame 10 and the wall . . . (legs with) resilient pads 44 formed of rubber . . . (are attached) so they may be replaced as they wear out”. (friction/padding benefit) U.S. Pat. No. 5,123,620 entitled ACCESSORY CONTAINER FOR LADDER, granted Jun. 23, 1992, by Bourne is an example of a container supporting against the rear portion of the back rail of a ladder. Bourne's FIG. 3 is redrawn here as Prior Art FIG. 3a. Prior Art FIG. 3b is Bourne's FIG. 3 embodiment on a leaning ladder. For his container to continue to support against the rear portion of the back rail of a ladder, its top edge would dig sharply into a vertical wall. Bourne does not provide, nor have a place for any rubber feet, like Morawski's feet 44, that might protect a wall if the ladder was leaned with the container in place. Bourne's container teaches away from securing a ladder a distance from a wall when leaned.

Often painting requires about a one or two-foot lift before using a ladder. Some users stand on what looks like a stool, but does not meet OSHA standards to be called a stool. An example is the 16″ tall plastic SIDE TABLE # 03937 by Syroco as seen on web site www.syroco.com. The surface area is a rough texture that is of benefit as a step stool but not so much as a table (rough surfaces collect dirt, and a recessed surface would better prevent slippage off a side table). Many purchasers of such items buy them to use them as a stool. They have 4 supporting feet, which is not often sure footing on outside ground which is rarely level.

Folding stools also have problems for use outside. Their small-diameter rod-like legs can sink into the ground. The stool steps are not deep, or their depth cannot be used without bumping ones chins. So the stool must be positioned just-so: away from an outside wall such that one can balance on the balls of ones feet. Users may need to lean on the wall they are painting. This may lead to transfer of paint or dirt between the user and the wall.

Des. Pat. No. 340,773 entitled LADDER TOP, granted Oct. 26, 1993, by Bartnicki et al. shows a laddertop with several through-and through holes for tools, and a round recessed platform portion of a size to support a quart of paint. Prior Art FIG. 4 is a sketch of his prior art laddertop FIG. 1, top view. Laddertop holes 66, 67, and 68 are noted. These noted holes are located on the far side of the laddertop, versus the larger two side holes which are on the laddertop front side, closest to ladder steps.

A laddertop surface design likely has to avoid being designed of a look to hold larger or more spillable objects than OSHA might allow. There is a narrow hook on the ladder back, of a size and shape to hang an object with a metal wire handle (plastic handles, like for spackle, don't fit on it). The only common item that could be hung from such a hook is a gallon can of paint (paint in quarts do not come with metal wire hangers). The hook is recessed into the ladder back, which allows the ladder to be leaned smoothly against a wall, which shows the designer recognizes that a ladder is often leaned against a wall. When a folding ladder is leaned against a wall it is often leaned at an angle more severe than when opened as an A frame. This leaves the laddertop tilted, versus being a level surface.

Many ladder manufacturers have through-and-through holes in their laddertop. Manufacturers include Werner®, Husky®, & Green Bull™.

Prior Art FIG. 5a is a prior art plastic crate, top perspective view. Heavy-duty prior art milk crates are often of two sizes: 12″×12″ I.D. top opening and 12″×18″ I.D. top opening. Prior art plastic storage/file crates for home use are often 12.5″×14″ I.D. Crates are of average 11″ deep. Prior Art FIG. 5b is a prior art plastic crate, cross-sectional view. The crate walls are made light-yet-strong substantially by narrow grid walls (like a honeycomb). All sections of the walls must be the same thickness such that the plastic flows evenly into the mold. This is why the corners of the crate are thin. To strengthen stressed areas of the crate, a denser pattern of grids, like near the crate's bottom rim, are added. Grid thicknesses are about 2 mm., with at least some grade for ease of ejection. Prior art metal ribbon bands have also been added on a crate rim for strength. The interior surfaces of the crate are smooth so molded crates can be ejected from the tool. Some prior art plastic crates are made with a percentage of glass fibers, added for strength. Plastic with glass fibers does not fill a mold well in narrow spaces, so crate walls are made thicker, requiring more plastic than a plastic crate with similar-strength grid walls. Also, glass fibers scratch the tool, reducing tool life.

The frame width near the base of prior art A-frame ladders is wider than near the top of same ladder. The laddertop of prior art ladders is commonly 13″ wide, and the top-most step is one foot down. The laddertop is commonly 14″ wide at that top step. Straight ladders are often closer to 16″ wide at the top.

### BRIEF SUMMARY OF THE INVENTION

The invention is substantially a box (5 walls, front wall absent) with a top inside-surface prop-stop means to hold a ladder's top portion a distance away from any vertical surface on which that ladder leans. The box is of a width to confine the outside sides of a prior art ladder's rails; of a top-wall depth to rest atop of a portion of same ladder; of a depth to substantially prop same ladder away from a vertical wall, of a length such that, when positioned as described, the box's bottom-wall's front edge can brace against the rear side of rails of same ladder.

### ADVANTAGES OF THE INVENTION

The box extends the ladder's useful height, provides 2 shelves, a larger contact area against a wall, and improved ladder safety. The box invention can just be thrown atop most straight or one-fold ladders. The box lifts a ladder away from a supporting wall, making the ladder function like a 4 to 6 foot taller ladder. Two boxes fixedly attached together allows the ladder to function as an 8 to 12 foot taller ladder. The box(s) are substantially lighter in weight than a ladder 4 to 12 feet taller. A user can reach higher areas without using a hard-to-balance, heavy, tall ladder. Because the weight of the ladder above where a user picks it up is reduced, the user can more easily move and balance the ladder. Such improved ladder control reduces the likelihood that the ladder will bump/ding siding, or fall and crash down on something or someone.

The box lets a user work on a wall directly in front of them and to both sides. Comparatively, a straight ladder’ rungs are in the way, preventing all but painting to a user's favored side, tilting the ladder which can cause a ladder to fall/slip sideways. Painting a wall directly in front of a user is easier and can allow a user to paint with wide strokes for a smoother finish. The invention makes working in tight spaces easier, accessible, and less dangerous, like under a home's eves. That is, some places under eves cannot be reached if a tall ladder were leaned against a wall. It reduces the chance a user would lean backwards to paint or work on eves, (leaning can instigate a fall). The box adds, or deepens and makes more level, a ladder's top platform, for holding supplies. The wide frictional surface against a wall improves ladder stability, and helps prevent siding from being marred. Many supplies can be safely stored under the ladder platform. The invention can be easily lifted off. When the box is off it may be used as a short stand-on platform, or three may be fixedly attached to make a taller step stool/platform. A rounded-edged, soft frictional (like rubber) backside keeps the siding from getting dinged, keeps the ladder from shifting, and adds friction when used off the ladder as a platform or as steps. Often painting requires one and two-foot lifts before using a ladder. One box can be used as a platform, perhaps 11″ high. As compared to balancing the balls of ones feet on a shallow step stool, the box as a platform supports the entire length of a users feet. When used indoors, or on smooth floor surfaces, frictional feet can be attached. Three boxes can be attached together like steps to make a really stable stool. When work, like painting, is finished, the box invention can be used to store supplies, like a prior art crate, and they can be stacked.

Most users, like homeowners, buy a simple A-frame, one-fold, all-purpose ladder. Sometimes they also get a small, like 20′, straight ladder. They may occasionally need a taller ladder or a specialty ladder. But they often compromise safety by stretching or bending backwards as compared to buying a specialized ladder for a not-so-often task. Since one or more boxes may be purchased long after the original ladder purchase, a user is more likely to buy the boxes to finish their project, and they do not have to worry about storing them. The box invention provides a potentially inexpensive way for a user to safely complete their project. A box embodiment may be designed to fit on only specific ladders, allowing the box maker to steer users to their ladders. Or an embodiment can be made to fit most ladders.

The box invention allows a user to stay balanced and the optimal distance from a wall, for easy sanding, painting, repairing, and more. FIG. 7 are sketches of a user painting, side view. They show five steps to a comfortable, fast, and efficient paint job. FIG. 7a shows a user standing on one box. FIG. 7b shows a user standing on a three-box formation. FIG. 7c shows a user leaning a prior art ladder against an outside wall, which is not recommended. FIG. 7d shows the user & ladder of FIG. 7c with one box attached. FIG. 7e shows the user & ladder of FIG. 7d with one more box attached. FIG. 7f shows the user next to three boxes stacked for storage.

### BRIEF DESCRIPTION OF THE DRAWINGS

Prior Art FIG. 1a is a sketch of a user painting on a ladder, front view

Prior Art FIG. 1b is a sketch of a user painting on a ladder, top view

Prior Art FIG. 1c shows views of users each moving a straight ladder

Prior Art FIG. 1d is a sketch of a user painting a truss, side view

Prior Art FIG. 1e is a force analogy diagram

Prior Art FIG. 2 is a sketch of a user on an L-formed multi-ladder

Prior Art FIG. 3a is Bourne's FIG. 3

Prior Art FIG. 3b is Bourne's FIG. 3 embodiment on a leaning ladder

Prior Art FIG. 4 is a sketch of a prior art laddertop, top view

Prior Art FIG. 5a is a prior art plastic crate, top perspective view

Prior Art FIG. 5b is a prior art plastic crate, cross-sectional view

FIG. 6a is a box embodiment, cross-sectional view

FIG. 6b embod. of FIG. 6a put on a prior art ladder, side/x sectional view

FIG. 6c is a box without any prop stop means, side/cross sectional view

FIG. 6d is a detail of the embodiment of FIG. 6b

FIG. 7 are sketches of a user painting, side view

FIG. 7a shows a user standing on one box

FIG. 7b shows a user standing on a three-box formation

FIG. 7c shows a user leaning a prior art ladder against an outside wall

FIG. 7d shows the user & ladder of FIG. 7c with one box attached

FIG. 7e shows the user & ladder of FIG. 7d with one more box attached

FIG. 7f shows the user next to three boxes stacked for storage

FIG. 8 is an embodiment with a frictional, curved surface, back view

FIG. 9 is a box embodiment with stored clips, side view

FIG. 10a is a box embodiment with plank and block prop-stops, side view

FIG. 10b is a box embodiment of FIG. 10a with a straight-top ladder

FIG. 10c is an embodiment with alternative attachment means, side view

FIG. 11a is a box embodiment, perspective view

FIG. 11b is a box embodiment, perspective view

FIG. 11c is a box embodiment with just post prop-stops, perspective view

FIG. 11d is the box of FIG. 11c with feet, perspective view

FIG. 12 is a three box assembly, side view

FIG. 13 shows a possible grate pattern for a box embodiment, side view

FIG. 14 are box embodiments, cross-sectional views.

FIG. 14a is the box of FIG. 11c

FIG. 14b is an embodiment with just a prop-stop plank

FIG. 14c is an embodiment with block extending the width of the box

FIG. 14d is the box of FIG. 11b

FIG. 14e is the box of FIG. 11d

FIGS. 15 show A-ladders with attached box leaning on a wall, side view

FIG. 15a shows a leaning ladder where box backside is vertical

FIG. 15b shows a leaning ladder where box top corner touches wall

FIG. 15c shows a leaning ladder where box bottom corner touches wall

FIG. 16 shows two boxes, positioned for attachment

FIG. 17 shows two boxes attached with a clip

FIG. 18 shows the X embodiment, front perspective view

FIG. 19a shows how crate embod. bolts on P.A. FIG. 4 laddertop, top view

FIG. 19b shows how embod. X bolts on a Werner laddertop, top view

FIG. 19c shows how embod. X bolts on a Husky laddertop, top view

FIG. 19d shows how embod. X bolts on a Green Bull laddertop, top view

FIG. 19e shows how embod. X clips on any laddertop, top view

FIG. 20 shows how embod. X clips on any laddertop, side view

FIG. 21a shows a user, straight ladder with one box, side view

FIG. 21b an incorrectly tilted straight ladder with one box, side view

FIG. 21c shows a user, straight ladder with no box, side view

FIG. 22a shows a box secured on a straight ladder, side x-sectional view

FIG. 22b shows the box of FIG. 22a, front view

FIG. 23 shows a bare frame box embod. w/blocks, front perspective view

FIG. 24 shows a bare frame box embod. w/posts, front perspective view

FIG. 25 shows an embod. with a deep prop-stop, front perspective view

FIG. 26a shows an embod. with side prop-stops, front perspective view

FIG. 26b shows a cross-sectional view of FIG. 26a

FIG. 27 shows an embodiment with a panel prop-stop, cross-sectional view

DESCRIPTION OF THE NOTATIONS

| | |
|---|---|
| 4 | a box embodiment |
| 7x | a prop-stop post |
| 7y | a prop-stop post |
| 7z | a prop-stop post |
| 8a | a prop-stop plank |
| 8b | a prop-stop plank |
| 8x | a prop-stop plank |
| 8y | a prop-stop plank |
| 9b | a prop-stop block |
| 9x | a prop-stop block |
| 9y | a prop-stop block |
| 10 | an box top side |
| 11 | an box back side |
| 12 | an box bottom side |
| 13 | a wall front edge |
| 14 | a back wall curved edge |
| 15 | an overmolded area |
| 16 | a back wall shoulder |
| 19-26 | metal ribbon clips |
| 45 | hole for a caulk gun or drill |
| 46 | a handle |
| 47 | a RHS ladder prop-stop |
| 48 | a LHS ladder prop-stop |
| 49 | a RHS hollow bin |
| 50 | a LHS hollow bin |
| 51 | holes for when post is used |
| 52 | a cord catch |
| 53 | a hole for clipping X together |
| 54 | a hole for a clip |
| 55a | a rubber foot |
| 55b | a rubber foot |
| 57 | a clip |
| 59 | a prop-stop |
| 60 | a location for a quart can |
| 61 | a location for a gallon can |
| 62 | a location for a hammer |
| 66 | a prior art laddertop hole |
| 67 | a prior art hole in a laddertop |
| 68 | a prior art hole in a laddertop |
| 70 | a LHS edge |
| 71 | a RHS edge |
| 72 | a bottom edge |
| 73 | a back surface |
| 74 | a LHS prop-stop |
| 75 | a RHS prop-stop |
| 76 | a post |
| 77 | a prior art ladder |
| 78 | a box side or brace |
| 79 | a box side or brace |
| 80 | a box or crate |
| 81 | a prop-stop plank |
| 82 | a RHS prop-stop post hole |
| 83 | a LHS prop-stop post hole |
| 84 | a RHS cavity |
| 85 | a LHS cavity |
| 86 | a right-hand side wall |
| 87 | a left-hand side wall |
| 88 | a P.A. straight ladder |
| 89 | a P.A. straight wood ladder |
| 90 | a rod |
| 91 | a RHS prop-stop block |
| 92 | a LHS prop-stop block |
| 98 | a post screw or pin |
| 99 | a box hole |

### DETAILED DESCRIPTION OF THE INVENTION

1. Description of One Embodiment of the Invention

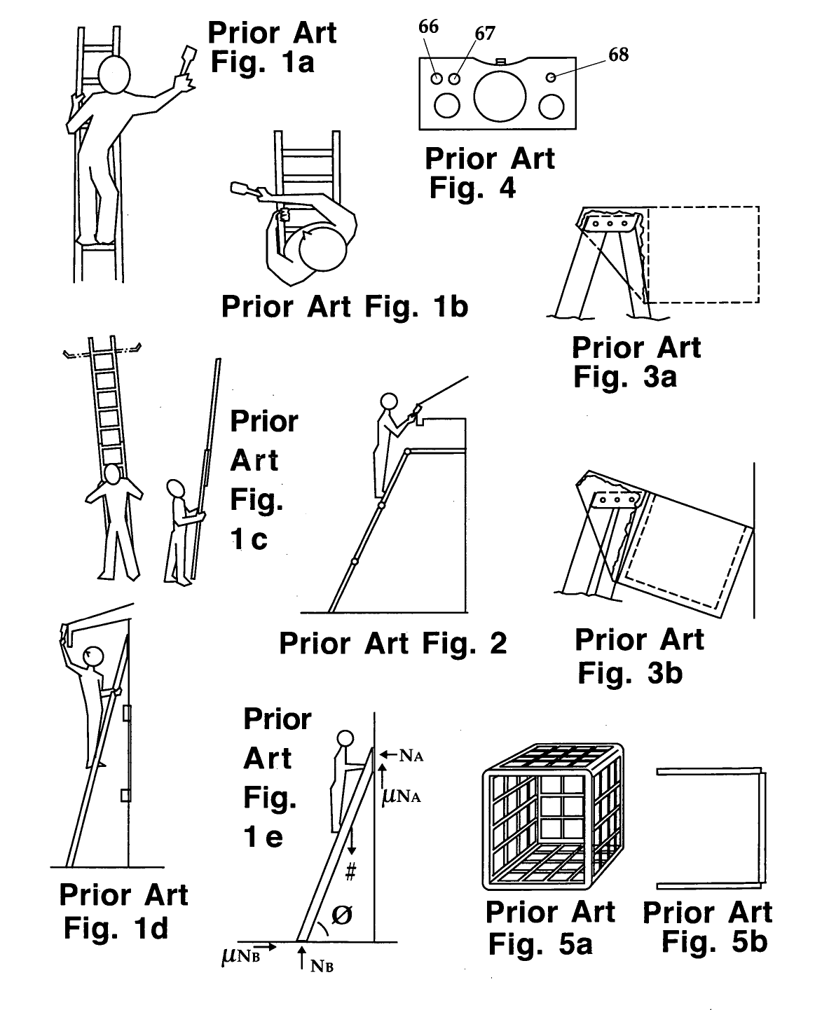

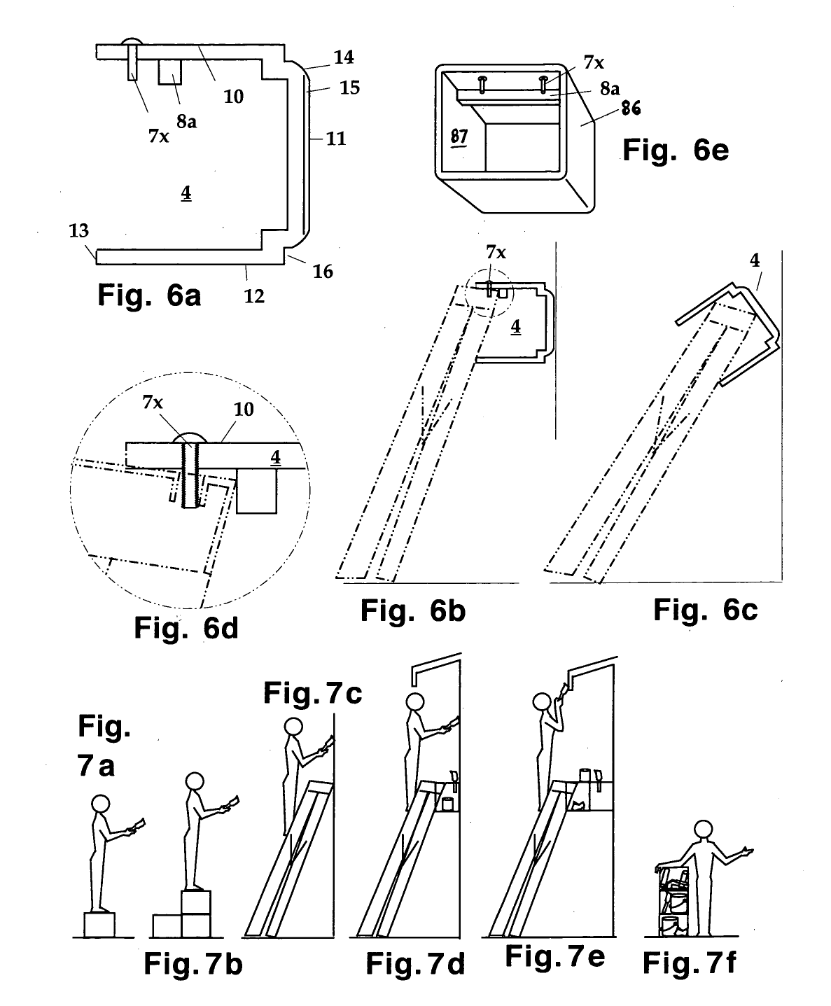

FIG. 6a is a box embodiment, cross-sectional view. Box 4 has top side 10, back side 11, bottom side 12, and bottom wall front edge 13. Notation 7x is a prop-stop post (opposite post not seen). The posts may be made with prior art bolts screwed into vertical female-threaded locations on the top side of the box. 8a is a prop-stop plank for most A frame ladders. (In this embodiment, the plank extends the full inside width of the box). These prop-stop means position substantially in the uppermost inside portions of the box and are fixedly attached to the box. [This same embodiment is shown in FIG. 6e, front perspective view, where 7x and 8a are noted, and RHS side wall 86 and LHS side wall 87 are noted.] 14 is a back wall curved edge, curved to keep back wall 11's edges from indenting exterior siding. 15 is a back wall overmolded area. Overmolding (like neoprene or other rubber) provides benefits: Rubber is soft to not dent siding, provides friction against a wall to help prevent a ladder top from shifting, and a frictional standing surface when the box is used as a stool. 16 is a back wall shoulder, for mating against/with her box's bottom wall front edge (like this box's edge 13).

FIG. 6b is the embodiment box 4 of FIG. 6a put over the top-most portion of a prior art ladder side/cross sectional view. The front/open side of the box faces towards the front side of the ladder. The ladder is footed on horizontal ground. The box with/plus the prop-stop means (like posts, or plank 8a, or both) together hold the ladder's top portion a distance away from the vertical surface on which the ladder is leaned. The box's back side rests substantially vertically against the shown vertical surface (like an exterior wall).

This prior art ladder has laddertop holes. Prop-stop post 7x positions inside one prior art laddertop hole, positioned substantially to the ladder's right side. A second unshown box post positions inside and opposite-side prior art laddertop hole. Note that the post is positioned in a hole substantially at the back portion of the laddertop. Note the front edge of the box extends only slightly over the front-to-back center of the laddertop.

FIG. 6c is box 4 without any prop stop means, side/cross sectional view. Though initially friction may keep a leaning ladder positioned as in FIG. 6b, with nearly any motion the laddertop will collapse towards the supporting vertical wall. Though, in this position, the box still distances the laddertop a bit away from the wall, the top edge of the box protrudes over the ladder's top step, obstructing a user. The Laddertop is no longer substantially horizontal for supporting supplies, and supplies cannot be stored inside the box.

FIG. 6d is a detail of the embodiment of FIG. 6b. Post 7x is of a smaller diameter than the prior art laddertop hole in which it is positioned. This allows the ladder to be at an angle different than the laddertop's holes, and lets box 4's top shelf/side 10 (and unseen shelf/side 12) position substantially level, or horizontal, for supporting supplies. Posts, like post 7x can have a high-friction surface, like a bolt's threads, which help grab the laddertop. This prevents any lifting of the box off of the laddertop by a user moving around on the ladder. If the posts are bolts they can each be attached by female threads of the molded box, or wih shallow nuts.

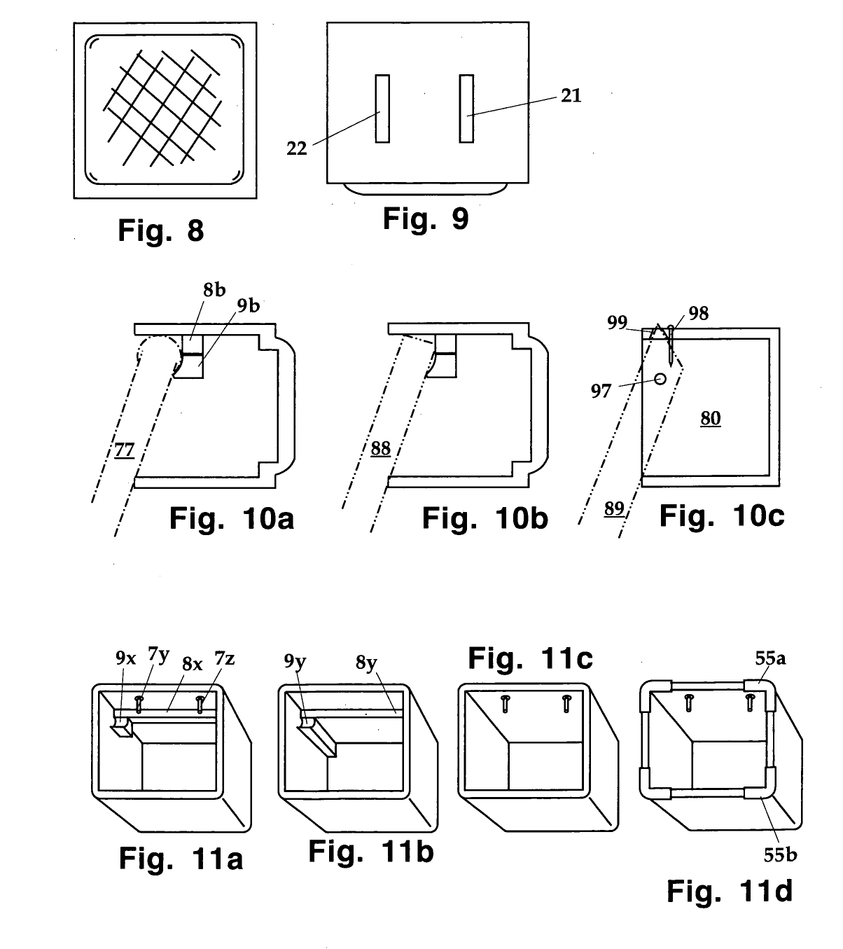

FIG. 8 is an embodiment with a frictional, curved surface, back view. This back side surface may be a rough surface, or rubber surface.

FIG. 9 is a box embodiment with stored snap-straps/clips 21 and 22 noted, side view. These clips, discussed later, may be used to attach boxes together. They may be made of ribbon steel, and fixedly attached to the box to just swing around and attach to another box. Or, they may be stored on either side, or both sides. They may alternatively be injection-molded attachments on the box.

Alternatively, a box embodiment can be made so a second or third post can position inside yet another prior art laddertop hole. Possible holes are like in Prior Art FIG. 4 holes 66, 67, and opposite-side hole 68. If at least two opposite-side posts are used in an embodiment, prop-stop plank 8a (shown in FIG. 6a) is not needed. Plank 8a may be used in conjunction with prop-stop posts or without any posts. Prop-stops are a means to force/distally brace/support support a leaning ladder's laddertop.

2. Description of other Embodiments of the Invention

FIG. 10a is a box embodiment with plank and block prop-stops, side view. Prior art ladder 77 has rounded-top rails. Both plank 8b and block 9b force the ladder rail tops away from a vertical wall that supports it. A taller plank alone can be a prop-stop. Blocks can be the prop-stop without the plank. FIG. 10b is a box embodiment of FIG. 10a when used with straight-top ladder 88.

FIG. 10c is a box embodiment with alternative attachment means, side view. This box is fixedly attached to ladder 89 by horizontal post 97 and/or post or screw 98. Box hole 99 can be for more ladder support & centering.

FIG. 11a is a box embodiment, front perspective view, posts 7y & 7z, and plank 8x, and block 9x noted. (opposite-side block unseen). Plank 8x is at least 2″ tall & can be 2″ deep; and block 9x may be 2″ wide. 2.5″ deep, 2″ tall.

FIG. 11b is a box embodiment, front perspective view. If this box were injection molded, plank 8y and block 9y could be molded like shelves (see FIG. 14c). FIG. 11c is a box embodiment with just post prop-stops, front perspective view. This two-post prop-stop embodiment is all the securing needed to attach to a laddertop embodiment like that shown in Prior Art FIG. 4. FIG. 11d is the box of FIG. 11c with feet, front perspective view. Such feet may be attached when the box is used as a stool or platform (back side up) on smooth surfaces, like an indoor floor or outside deck.

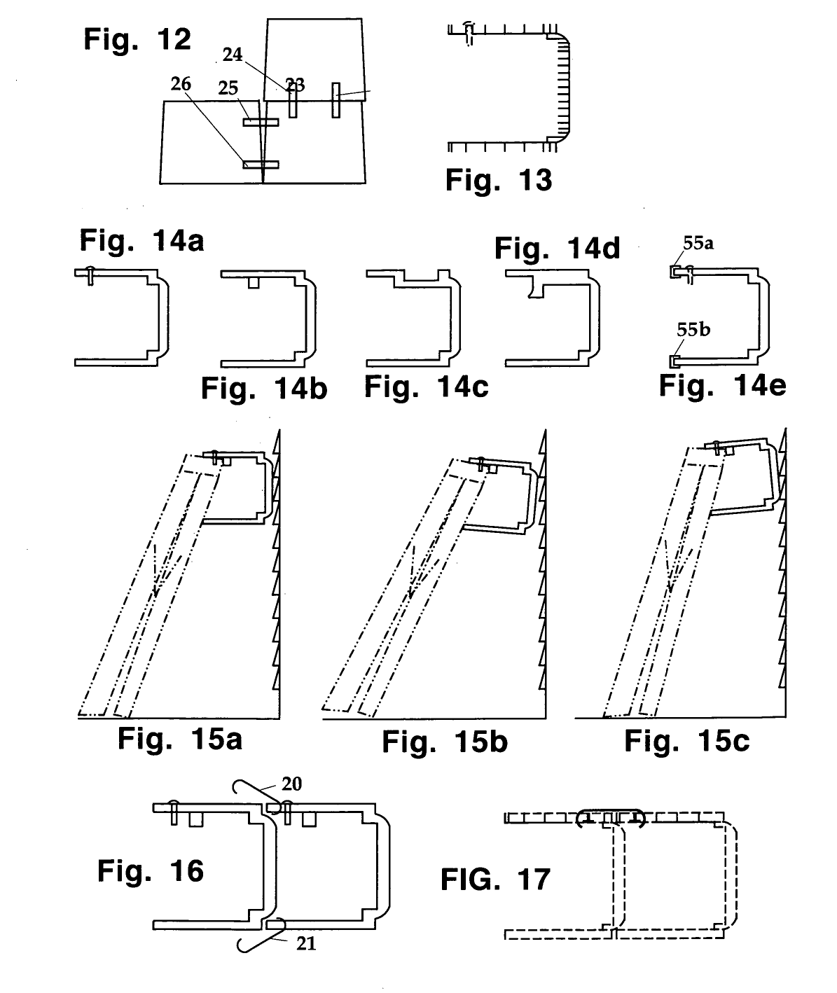

FIG. 12 is a three box assembly, side view. Clips 23 and 24 vertically fixedly attach two stacked boxes. The boxes are vertically fixedly attached to with two clips on the assembly's opposite, unseen side. The box to the left is horizontally fixedly attached the bottom stacked box with clips 25 and 26. Similarly, it is horizontally fixedly attached to box with two clips on the assembly's opposite, unseen side. This assembly forms a step stool.

3. Methods of Constructing a Box Embodiment

A box embodiment may be injection molded in a form and manner similar to prior art milk crates or storage crates. FIG. 13 is a possible grate pattern for an injection-molded box embodiment; cross-sectional RHS view. As an embodiments back side is preferably smooth, grating (for stand-on strength) can be on the inside surface of the back wall and still pull out of the injection mold tool . Interior grating can be back-to-front stronger because of inside-corner grate parts. Prop-stop posts may be inserted bolts.

A prop-stop plank or prop-stop blocks can be fixedly attached as a secondary operation, or be formed by injection molding.

FIGS. 14 are box embodiments, cross-sectional views. FIG. 14a is the box of FIG. 11c. FIG. 14b is an embodiment with just a prop-stop plank. FIG. 14c is an embodiment with plank extending the width of the box. The plank can be a hollow cavity where its interior surface is the prop-stop and its exterior surface is a recessed portion of the box's top side. FIG. 14d is a cross-section of FIG. 11b. FIG. 14e is the box of FIG. 11d, feet 55a & 55b are noted.

FIGS. 15 show ladders with attached box leaning against a vertical wall, side view. FIG. 15a shows a leaning ladder where box back side is vertical. The force against the wall is distributed equally between beveled siding layers. FIG. 15b shows a leaning ladder where box top corner touches wall. More force is placed against one upper layer of such siding. FIG. 15c shows a leaning ladder where box bottom corner touches wall. More force is placed against one lower layer of such siding. These figures show a benefit of having box backside curved edges and back rubber-overmolded.

All box embodiments shown are substantially rectangular with substantially planular sides.

FIG. 16 shows two boxes, positioned for attachment by clips 20 and 21. FIG. 17 shows two boxes attached with a clip. Box grating is somewhat shown. An attachment means may be accomplished by using clips, which can be hooked-ended pieces of ribbon metal. The T-shaped portion of box grating provides a post-like area for which a hook's end can hook/rotate around. The clips can be pried off by hand. Such clips can be somewhat loosely attached to a box's side, like in FIG. 9.

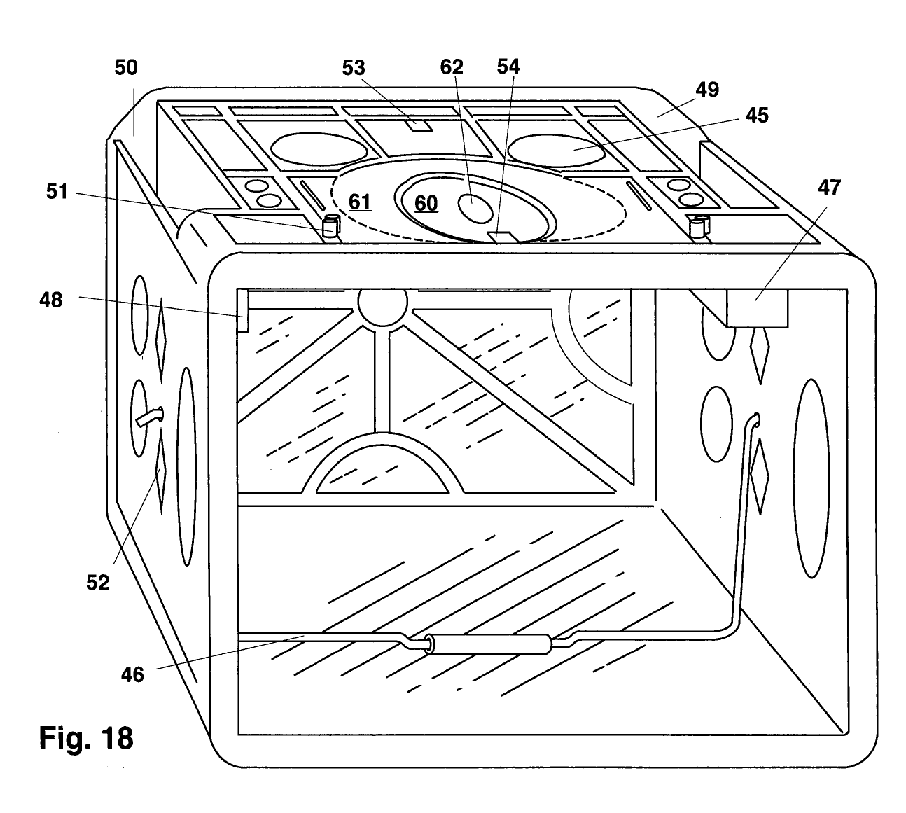

An embodiment may be made more useful by adding holes for tools, etc. One such embodiment, for ease call it X embodiment, is shown in FIG. 18, front perspective view. It shows a hole for caulk gun or drill (hole 45). Inside handle 46 makes it easy to carry the box, like if a user filled the box with tools, brought it to the ladder, then dumped the tools out. RHS prop-stop 47, LHS prop-stop 48 are formed by hollow bins that are open on the top side of the embodiment. These hollow bins are RHS bin 49 and LHS bin 50. Post holes 51 are for posts, like bolts previously described. The embodiment has diamond-shaped (cut-out hole) cord catcher 52. Two boxes can be clipped together. The back-most hole 53 is for a clip to clip two boxes together. A clip would clip between hole 53 and another box's front hole, like hole 54. This embodiment shows a raised ring spot to secure a quart of paint (location 60), a recessed spot to place a gallon of paint (location 61), and a hole for a hammer 62.

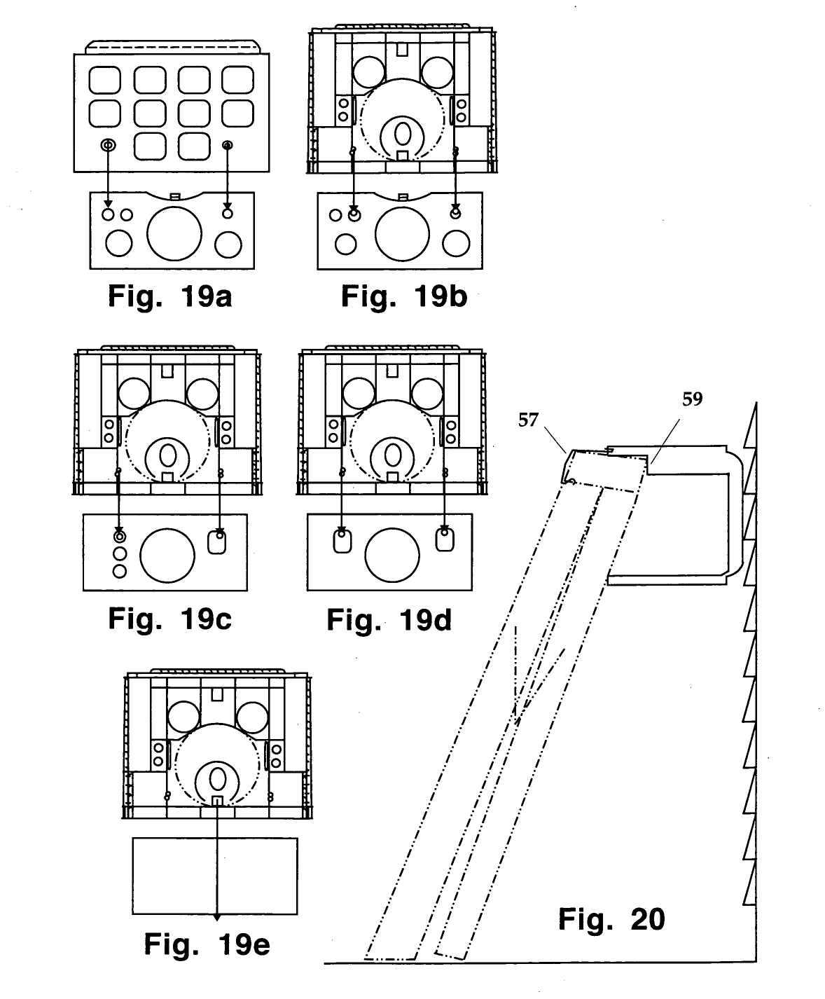

FIG. 19a shows how a crate embodiment (with 2 filled-in solid areas) could bolt on P.A. FIG. 4 laddertop, top view, where the arrows indicate where the bolts of the crate fit into the holes on the laddertop. FIG. 19b shows how embodiment X bolts on a Werner® laddertop, top view. FIG. 19c shows how embodiment X bolts on a Husky® laddertop, top view. FIG. 19d shows how embodiment X bolts on a Green Bull™ laddertop, top view. FIG. 19e shows how embodiment X can clip on any laddertop, top view.

FIG. 20 shows embodiment X clipped to any laddertop, side view. Front restricter clip 57 holds the ladder to the box against prop-stop 59. This lets a user move the ladder with the box securely attached, and holds it from slipping against the box for ANSI Bottom Slip Test. [A-frame ladders alone aren't designed to pass this test.] The ANSI test is where dead weight is placed on the ladder and 50 pounds of force pushes outward at the base of a ladder that is sitting on sanded plywood. The ladder should not move more than 25″. A box marked “never use box with ladder on smooth flooring” likely avoids the need to pass the ANSI test. Straight ladders are required to have enough sure footing to pass the ANSI test. Straight ladders, which tend to be much taller than A-frame ladders, are often needed to reach under eves. But because the ladder must fit on the wall, eves cannot be reached, even if one straightens the ladder at a non-safe angle.

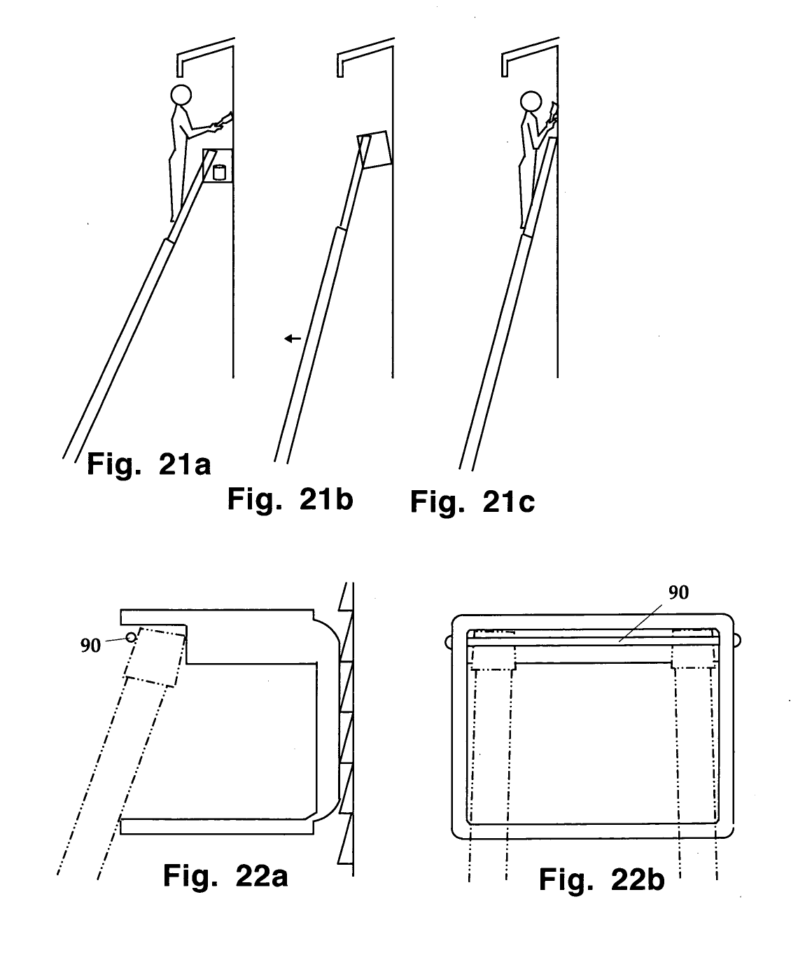

FIG. 21a shows a user, straight ladder with one box, side view. FIG. 21b an incorrectly tilted straight ladder with one box, side view. Because the box won't sit against the wall flat when the ladder is over-straightened, a user is more likely to adjust the ladder to the correct height to width ratio, and be safer. FIG. 21c shows a user, straight ladder with no box, side view. Not only does a user (without a box) have nowhere to place their paint or brushes, they will have to lean backwards to paint the eaves, which is an unsafe position, and causes many ladder accidents.

FIG. 22a shows a box secured on a straight ladder, side cross-sectional view. The top of a straight ladder is closer to being 16″, so the box embodiment is wider than that for an A-frame ladder. An easy way to secure a straight ladder to the box is with a rod, like rod 90. This rod may be secured to the frontward-top-most portions of the box's sides. This restricter rod functions like the front clip for an A-frame ladder. It holds the box on the ladder in place while moving the ladder. Other resricter means may be used. Rod 90 of FIG. 22a is also shown in FIG. 22b in the front view of the box.

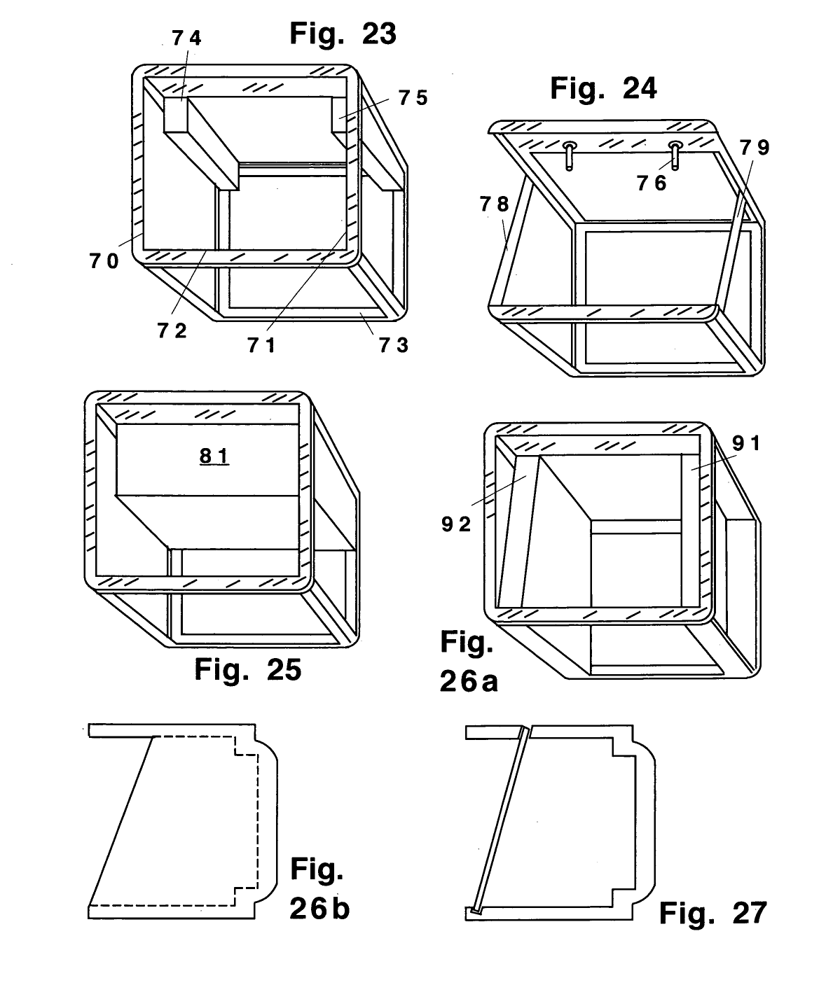

Though semi-enclosed sides have been drawn in all previously-shown embodiments, a box embodiment does not need them to function as a laddertop support. FIG. 23 shows a bare frame box embod. with blocks (blocks hollow like the bins in FIG. 18), front perspective view. LHS edge 70 and RHS edge 71 confine a prior art ladder from slipping sideways, like if a user were to to try to position the box wrong or lean sideways on the ladder in use. Bottom edge 72 sits against the backside of a ladder's rails. Though the ladder is held away from the wall with LHS and RHS prop-stops 74 and 75, bottom edge 72 is like a guide to position the ladder at the proper height to depth ratio. Compare this to perhaps two posts alone pushing the ladder away from a wall. Two posts alone would create tremendous stress at the angular point where the laddertop meets the posts (like the problem with the prior art multi-ladder joints shown in Prior Art FIG. 2). The box's bottom front edge acts like a lever arm, supporting against the ladder's back rails, like Bourne's FIG. 3 (P.A. FIG. 3), & supports better than the angular support of Casada's arm braces (FIG. 1, n.14). The unseen backside 73, is but a fairly hollow rectangle. Still this wide surface area would be enough to set against a wall without marring siding. It's two advantages: It may be lighter in weight than a box with larger-surfaced sides, & shelves may be placed on top and bottom only when desired.

FIG. 24 shows a bare frame box embodiment with posts, front perspective view. Posts like post 76 keep a ladder from moving sideways, and the left hand and right hand sides (or side braces) 78 and 79 of the crate are there for but strength. Unless the box were made of steel, something equivalent in strength to side braces would still be needed to keep the box top and bottom front edges from bending up or downward. This embodiment is also just essentially a box with one end open and a prop-stop means.

4. Embodiments for Future Art Ladder Tops

Future Art laddertops could include through-and-through slits, so box posts could be made as hooks. Future Art laddertops could include pop-up stop-prop posts. So the invention can also be a box, such that when the box is placed on a laddertop, there is a prop-stop means between the box and the laddertop to brace the laddertop away from the wall by means of a substantial portion of the depth of the box.

5. Common Specifications of the Invention

Box interior width can be, but is not limited to being, 15″ for an A-frame ladder and 17″ for a straight ladder. Box interior length can be, but is not limited to being 12.5″, which would be even with the first step down from an A-frame laddertop. Box exterior depth can be, but is not limited to being 12″ (box depth becomes step height when used as a stool). The prop-stop means may be, but is not limited to being, 2″ back (from the front-most portion of the box lip) for posts, or 3- 13/16″ back (from the front-most portion of the box lip) for planks or blocks.

6. The Original Embodiments of the Invention Using Prior Art

Applicant's original prototype versions of the invention were made with prior art plastic crates. Two bolts were attached to a prior art laddertop through laddertop holes, and secured with nuts. So, when the crate gets placed atop the ladder, the bolts fit through the holes of a crate. When the crate was off, the laddertop had two bolts sticking up, making placing items on it more difficult (see F.A. solution 2 paragraphs above). A heavy towel, thick clothing, or a dense piece of foam were wrapped around the box back side to keep the sharp grated crate edges from digging marks into soft exterior cedar siding. Two crates were fixedly attached with screws. Crates were attached to a straight wood ladder with screws straight down from the top of the box into the top of both rails.

7. Distinguishing Characteristics of the Invention

Items that visibly distinguish the invention from prior art include the box having prop-stop(s), smooth, versus grated, curved-cornered back wall, an overmolded bottom, interior grating on the inside back wall, &/or a method to clip one box to another.

8. Materials

The box portion of the invention may be, but is not limited to being, constructed from plastic, wood, metal, fiberglass, or a combination thereof. The posts may be, but is not limited to being, constructed from plastic, wood, metal, fiberglass or a combination thereof. The plank portion of the invention may be, but is not limited to being, constructed from plastic, wood, metal, fiberglass, or a combination thereof. The block portion of the invention may be, but is not limited to being, constructed from plastic, wood, metal, fiberglass, or a combination thereof.

9. Unobviousness

Milk crates of a size and shape to make a box invention have been around at least since milk was sold in bottles and carried in crates. Wood crates for other uses have been in use for centuries. Ladders may have been around likely since man started building structures. Since the creation of crates or boxes, others have had the opportunity to screw an old wood straight ladder to a box/crate. FIG. 10c showed how an old wooden ladder could be screwed to a wood crate (or metal milk crate or plastic milk crate) in from the side or straight down. Attachment could be screws inserted through crate 80 to ladder 89, horizontally attached through hole 99 or with screw or pin 98). Metal milk crates likely had holes of a size for the top of a straight ladder to protrude partially though, between the metal grid, which would have produced a prop-stop means. As the advantages of such attachment, and simple attachment at that, are so numerous, the fact that nothing similar has been patented is proof of unobviousness. Ladders are involved in hundreds of thousands of accidents per year. As the invention so improves safety even for those who do not use ladders properly, it certainly solves a long-felt, long-existing, and unsolved need. No other patent found taught an under-the-platform shelf in combination with a leaning ladder support. Placing a box oddly on top of a laddertop certainly produces a most unexpected result.

10. Other Embodiments

FIG. 25 shows an embodiment with deep prop-stop plank 81, front perspective view. This prop-stop extends downward from the box's top wall. It could actually extend all the way to the bottom of the box, so long as the box's exterior were box-like. The prop-stop is shown as extending downward about 6″ . Such a deep plank (or top bin) restricts the space inside the box for supplies, but it nonetheless functions as a laddertop support and tray. It may have unknown advantages.

FIG. 26a shows an embodiment with RHS prop-stop block 91 and LHS prop-stop block 92, front perspective view. These opposite-side prop-stops extend the entire heighth of the box. These blocks also reduce the useable space inside the box for supplies a bit, but it nonetheless functions as a laddertop support and tray. FIG. 26b shows a cross-sectional view of FIG. 26a. The top-portion of each prop-stop block can position 3-4″ back from the front of the box. The bottom portion of each prop-stop block can also be 3-4″ back from the front of the box. However, in this drawing the bottom portion of the blocks position 0″ back from the front of the box. The drawing FIG. 26a shows each block extends about 2″ (can be a bit less) towards the center of the box. The blocks could be any greater width, including being the full width of the box.

A prop-stop the full width of the box could be made by inserting a flat board down from the top into groves in the box's bottom and side walls, such as is shown in FIG. 27: an embodiment with a panel-style prop-stop plank, cross-sectional view. The uppermost portion of the plank-panel is substantially 3-4″ back from the front side. A prop-stop plank could be angled as the side blocks are in FIG. 26b, or it could be straight, where the bottom portion of the plank is also 3-4″ back from the front side.

11. Misc.

Refer back to FIG. 1e. ANSI does bottom slip test for a leaning/straight ladder . Angle 75.5°, load (200-300#)—3rd step down, plywood floor & wall, 50# pull 1″ above test surface. A-frame folding ladders are not ANSI specified for leaning against a wall. With a box on the laddertop, the surface against the wall is larger, and with a neoprene/santoprene overmold, frictional force against slippage is increased/ improved. The box is designed for use on frictional ground.

Prior art injection molded crates have had interior wall steps, the largest step known, from an interior wall towards the box center is ⅜″ within 1″ of the box rim. This prior art step has value to strengthen the box rim. No prior art injection molded crate was found to have a step exceeding 1.5″ , or have a step 3″ or more back from a crate lip/edge. Such prior art steps are not far enough from the lip of a crate to position a laddertop securely and at the proper angle. Such shallow prior art steps are not wall-to-center long enough to prop-stop a ladder from slipping off. RHS & LHS are the abbreviations used for right-hand side & left-hand side respectively. A-frame ladders are shown, and considered to be in all descriptions when leaned, in the closed position, where the rails of the ladder lay substantially parallel to each other. A box with prop-stop can be made to fit both A-frame & straight ladders.

The front side of a box is substantially parallel with the back side of the box in all shown embodiments, though it is not necessary to function, but if not parallel it would not double as a step stool. Though the LH and RH sides are drawn parallel to each other, and the top side and bottom side are drawn parallel to each other, for injection molding they angle away from each other towards the front side of the box (like 1-4 degrees each side).

The box substantially keeps a straight ladder at the preferred angle (2 ft up or 2.5 ft. up to 1 ft. out). It does this due to three benefits: There is increased friction when the whole back of the box is against the wall improving ladder stability. Placing the box square also makes the box's top and under shelf level. Therein the box invention can reduce the opportunity for a user to fall.

12. Description for Claims

The invention is substantially a prop-stop means used in combination with a box (a box combined with a prop-stop means when placed on a ladder). The box substantially has a front side, a right-hand side, a left-hand side, a back side, a top side, and a bottom side. The front side is substantially open. The box is of a size and shape to fit over the top-most portion of a prior art ladder. When the box is placed over the top-most portion of a ladder (with the box front side facing towards the front side of the ladder), a portion of the (inside) top side of the box rests on top of the ladder. And with the ladder being footed on horizontal ground, the box with/plus the prop-stop means together are of a size and shape to hold the ladder's top portion a distance away from a vertical surface on which said ladder is leaned and, when so leaned, said box back side can rest substantially vertically flat against that vertical surface.

The prop-stop means can be fixedly attached to the box (in future art it might be fixedly attached to a ladder). The prop-stop means can be posts, blocks, a plank, or combination thereof. In use, the prop-stop means positions substantially inside portions of the box. The plank can be a hollow cavity where its interior surface is as a prop-stop and its exterior surface is as a recessed portion of the box's top wall. The blocks can be LHS and RHS hollow cavities where their interior surface is as a prop-stop and their exterior surface is as a pair of recessed bins whose opening is from the top portion of the box's top wall, like shown and described with FIG. 18. The blocks can start about 3″-4″ back from the front box opening. The blocks can be substantially 2″ tall or taller. Prop-stop posts, when part of an embodiment, can position substantially 2″ back from the front box opening, and extend into the box substantially 1″ or more. They can extend downward from the box's top side or extend inward from the sides. The depth of a box (distance from the open front wall to the back wall) may be at least 9″. [9″ was chosen at random. The less deep the box, the less it pushes the top of the ladder away from the wall.]

The plank can be a step, where the box top wall is recessed 2″ or more towards the inside of the box.

The box can be of a size and shape to fit over a ladder top. [Though, in a top-side post embodiment the upper portion of the box need only be wide enough to support the posts, all embodiments must be wide enough so the bottom front lip of the box can rest against the back side of a ladder's rails when leaned as previously described.] When the prop-stop means is just a plank or blocks, the box's side walls are of a size and shape to substantially confine the ladder rails from shifting sideways. With the open side facing forward, and the box positioned on an A-frame ladder, the box can be of a length to position the bottom wall of the box substantially level with the ladder's first step. When positioned, the bottom wall to the box rests against the back side of a ladder's rails. The heighth of the box can be substantially 9″ or more [again, 9″ chosen at random. the shorter the height, the less leverage the box has against the ladder's back rails].

All prop-stops fixedly attached to the box extend medially into the box, or are positioned inside the box. Rear and back (like in ladder rail description) are but two words with the same meaning in this text. Prop-stops are described as positioning like 3-4″ back from the front side; more correctly: the front-most PORTION of the prop-stop directly beneath the top side is what is being described. The following terminology has been added in case claims must be more descriptive: A box, prop-stops, and ladders have proximal (next to/nearest points/centers), medial centers, distal sides, peripheral points away from centers. A box has interior wall surfaces. A box may have five sides being hollow, graded, solid, or combination thereof, and a sixth side open.

I claim:

1. A box, said box having substantially a front side, a right-hand side, a left-hand side, a back side, a top side, and a bottom side; said front side being substantially open; said box being a size and shape to fit a portion of said top side over the top-most portion of a prior art ladder; said box having a bottom's side front edge;
and a prop-stop means;
such that, in use, when:
said box is placed over said top-most portion of said ladder with said box front side facing towards the front side of said ladder and a portion of said top side resting on top of said ladder and said ladder being footed on horizontal ground, said box plus said prop-stop means together of a size and shape to hold said ladder's top portion a distance away from a vertical surface on which said ladder is leaned, when so leaned, said box back side can rest substantially vertically flat against said vertical surface, and said bottom's side front edge resting against a portion of said ladder's upper back rails.

2. The box of claim 1, said box having an inside portion, where said prop-stop means being fixedly attached to said box and extending medially into said inside portion.

3. The box of claim 2, where said prop-stop means being a plank.

4. The box of claim 3, where said plank extending at least 2″ medially downward in from said box top side.

5. The box of claim 4, said box having an uppermost inside portion, where said plank having a top-most portion, said plank front-most portion positions least 2″ backward in from said box front side in said uppermost inside portion.

6. The box of claim 5, where said box being at least 9″ (front-to-back side) deep.

7. The box of claim 1, where said prop-stop means being a pair of opposite-side left and right hand side blocks, said box having an uppermost inside portion, and said blocks being substantially attached to said uppermost inside portion.

8. The box of claim 7, where said blocks extending at least 2″ downward in from said box top side.

9. The box of claim 8, said box having an uppermost inside portion, where said blocks each having a top-most portion, said blocks' front-most portion positions least 2″ backward in from said box front side in said uppermost inside portion.

10. The box of claim 9, where said box being at least 9″ deep.

11. The box of claim 1, said box having an uppermost inside portion, where said prop-stop means being a pair of opposite-side left and right hand side posts, where, in use, said posts position substantially inside said uppermost inside portion.

12. The box of claim 11, where, in said use, said posts position substantially 2″ back from said box's front side.

13. The box of claim 2, where said prop-stop means being a pair of opposite-side left and right hand side posts, said box having an uppermost inside portion, and said posts being substantially attached to said uppermost inside portion.

14. A box, said box having substantially a front side, a right-hand side, a left-hand side, a back side, a top side, and a bottom side; said front side being substantially open; said box having a width, said box having a depth; said box having a heighth;
said box width being 14″ to 18″, said depth being 9″ to 25″, said heighth being 9″ to 18″, said box having an uppermost inside portion;
and said box having a prop-stop means.

15. The box of claim 14, where said prop-stop means being a pair of opposite-side left and right hand side blocks; said blocks extending medially into said box at least 1.5″ sideways from said left hand side and right hand side sides, said blocks extending medially 1.5″ downward from said box top side; and said blocks having a front-most portion, said front-most portion being substantially 3-4″ back from said front side at said uppermost inside portion.

16. The box of claim 14, where said prop-stop being a plank, said plank extending medially into said box at least 1.5″ downward from said box top side; said plank having a front-most portion, and said front-most portion being at least 2″ back from said front side in said uppermost inside portion.

17. The box of claim 14, where said prop-stop means being a pair of opposite-side left and right hand side posts, said posts fixedly attached to said top side, positioning medially into said box at least 1.5″ sideways from said left hand side and right hand side sides, extending at least 1″ downward from said box top side; and
substantially 2″ back from said front side in said uppermost inside portion.
